(19) United States
(12) Patent Application Publication
(10) Pub. No.: US 2013/0136961 A1
(43) Pub. Date: May 30, 2013

(54) SECONDARY BATTERY

(71) Applicants: Minyeol HAN, Yongin-si (KR); Sangwon Byun, Yongin-si (KR); Haekwon Yoon, Yongin-si (KR)

(72) Inventors: Minyeol HAN, Yongin-si (KR); Sangwon Byun, Yongin-si (KR); Haekwon Yoon, Yongin-si (KR)

(21) Appl. No.: 13/489,593

(22) Filed: Jun. 6, 2012

(30) Foreign Application Priority Data
Nov. 30, 2011 (KR) 10-2011-0127379

(51) Int. Cl. H01M 10/42

(52) U.S. Cl. 429/61

(57) ABSTRACT

A secondary battery includes an electrode assembly having a first electrode, a second electrode and a separator between the first electrode and the second electrode, a first collector plate having a first connection part connected to the first electrode and a first extension part extending from the first connection part, the first extension part including a fuse part located therein, a case accommodating the electrode assembly, a first electrode terminal penetrating the case and connected to the first extension part, and a sub terminal penetrating the case and electrically connected to the first extension part. The sub terminal is connected to the first extension part between the first connection part and the fuse part. The first electrode terminal is connected to the first extension part between the fuse part and an end of the first extension part.

### BACKGROUND

1. Field

Embodiments relate to a secondary battery.

2. Description of the Related Art

Secondary batteries, specifically, large-capacity batteries in which several to tens of battery cells are connected to form a pack, may be used as the power source of motor driven devices such as hybrid electric vehicles.

A secondary battery may be fabricated by housing an electrode assembly including a positive electrode plate, a negative electrode plate, and a separator interposed therebetween as an insulator, and an electrolyte in a case, and sealing an opening of the case with a cap assembly having electrode terminals.

### SUMMARY

According to an embodiment, there is provided a secondary battery including an electrode assembly including a first electrode, a second electrode and a separator between the first electrode and the second electrode, a first collector plate including a first connection part electrically connected to the first electrode and a first extension part extending from the first connection part, the first extension part including a fuse part located therein, a case accommodating the electrode assembly, a first electrode terminal penetrating the case and connected to the first extension part, and a sub terminal penetrating the case and electrically connected to the first extension part, wherein the sub terminal is connected to the first extension part between the first connection part and the fuse part, and the first electrode terminal is connected to the first extension part between the fuse part and an end of the first extension part.

The first electrode terminal and the sub terminal may be disposed such that when the fuse part is melted, the first electrode may be electrically connected only to the sub terminal.

The first extension part may include a first electrode terminal hole through which the first extension part and the first electrode terminal are connected and a sub terminal hole through which the first extension part and the sub terminal are connected.

The first electrode terminal may be electrically connected to the case. The cap assembly may include an insulating member between the sub terminal and the case. The cap assembly may include a second electrode terminal that penetrates the case. The second electrode terminal may be connected to the second electrode.

The second electrode terminal may be connected to the second electrode through a second collector plate. The second collector plate may include a second connection part connected to the second electrode and a second extension part extending from the second connection part and having a terminal hole through which the second electrode terminal is coupled to the second extension part.

The secondary battery may further include a short circuit member that induces a short circuit between the second electrode terminal and the case when an internal pressure of the secondary battery exceeds a preset pressure.

The cap assembly may include an insulating member between the second electrode terminal and the case.

The secondary battery may further include a resistor that electrically connects the first electrode terminal and the sub terminal. The resistor may be positioned on an outer portion of the case. The resistor and the fuse part may be electrically connected to each other in parallel. The resistor may have a resistance value of 100 mΩ or higher.

The case may include a cap assembly including a cap plate coupled to the case. The first electrode terminal, the second electrode terminal and the sub terminal may penetrate the cap plate.

The first electrode terminal may be electrically connected to the cap plate. The secondary battery may further include a first insulating member between the sub terminal and the cap plate and a second insulating member between the second electrode terminal and the cap plate.

The secondary battery may further include a resistor that electrically connects the first electrode terminal and the sub terminal, the resistor being on an outer portion of the cap plate.

### BRIEF DESCRIPTION OF THE DRAWINGS

Features will become apparent to those of ordinary skill in the art by describing in detail exemplary embodiments with reference to the attached drawings, in which:

FIG. 1 illustrates a perspective view of a secondary battery according to an embodiment;

FIG. 2 illustrates a cross-sectional view of the secondary battery taken along the line I-I′ of FIG. 1;

FIG. 3 illustrates an enlarged cross-sectional view of a region 3 shown in FIG. 2;

FIG. 4 illustrates a perspective view of a first collector plate shown in FIG. 3;

FIG. 5 illustrates a cross-sectional view of a state in which an inverting plate is inverted due to an over-charge and makes contact with a short-circuit plate, corresponding to a state shown in FIG. 2;

FIG. 6 illustrates an enlarged, cross-sectional view of a region 3 shown in FIG. 6;

FIG. 7 illustrates a cross-sectional view corresponding to FIG. 2, illustrating a secondary battery according to another embodiment; and

FIG. 8 illustrates an enlarged, cross-sectional view of a region 8 shown in FIG. 7.

### DETAILED DESCRIPTION

Korean Patent Application No. 10-2011-0127379, filed on Nov., 30, 2011, in the Korean Intellectual Property Office, and entitled: “Secondary Battery,” is incorporated by reference herein in its entirety.

Example embodiments will now be described more fully hereinafter with reference to the accompanying drawings; however, they may be embodied in different forms and should not be construed as limited to the embodiments set forth herein.

In the drawing figures, the dimensions of layers and regions may be exaggerated for clarity of illustration. Like reference numerals refer to like elements throughout.

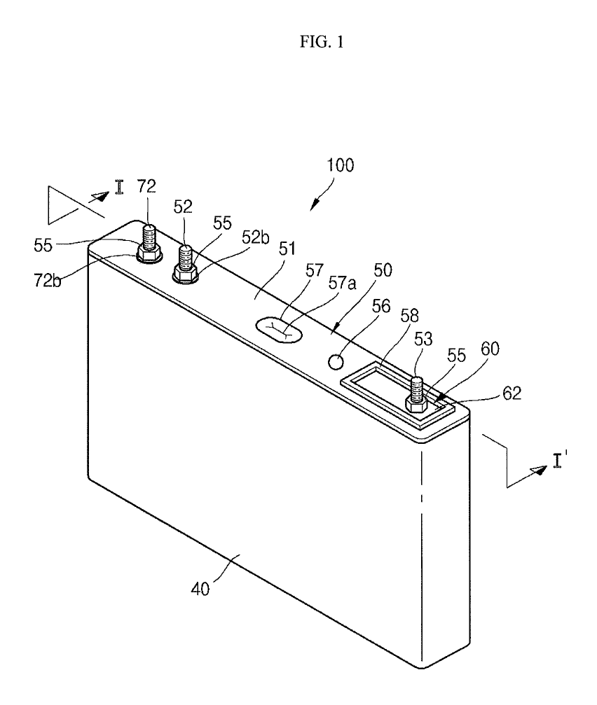

Referring to FIGS. 1 to 3, the secondary battery 100 according to an embodiment may include an electrode assembly 10, a first collector plate 20, a second collector plate 30, a case 40, a cap assembly 50, a short-circuit member 60, a first electrode terminal 52, a second electrode terminal 53 and a sub terminal 72.

The electrode assembly 10 may be formed by winding or laminating a stacked structure of a first electrode plate 11, a separator 13 and a second electrode plate 12, which may be formed as thin plates or foils. As an example, the first electrode plate 11 may function as a positive electrode, and the second electrode plate 12 may function as a negative electrode.

The first electrode plate 11 may be formed by coating a first electrode active material such as a transition metal oxide on a first electrode current collector made of a metal foil such as aluminum. The first electrode plate 11 may include a first electrode non-coated portion 11a on which a first active material is not coated. The first electrode non-coated portion 11a may constitute a current flow path between the first electrode plate 11 and the outside of the first electrode plate 11. Other materials for the first electrode plate 11 besides those listed herein may be used.

The second electrode plate 12 may be formed by coating a second electrode active material such as graphite or carbon on a second electrode current collector formed of a metal foil such as nickel or copper. The second electrode plate 12 may include a second electrode non-coated portion 12a on which no second electrode active material is coated. The second electrode non-coated portion 12a may constitute a current flow path between the second electrode plate 12 and the outside of the second electrode plate 12. Other materials for the second electrode plate 12 besides those listed herein may be used.

Although it is described herein that the first electrode plate 11 is a positive electrode and the second electrode plate 12 is a negative electrode, in other implementations, the polarities of the first electrode plate 11 and the second electrode plate 12 may be reversed.

The separator 13 may serve to prevent short circuits between the first electrode plate 11 and the second electrode plate 12 and to allow lithium ions to pass. The separator 13 may be formed of a polyethylene (PE) film, a polypropylene (PP) film, or a composite film of PE and PP. In other implementations, other materials besides those listed herein may be used for the separator 13.

A first collector plate 20 and a second collector plate 30 may be coupled to opposite ends of the electrode assembly 10 to be electrically connected to the first electrode plate 11 and the second electrode plate 12, respectively.

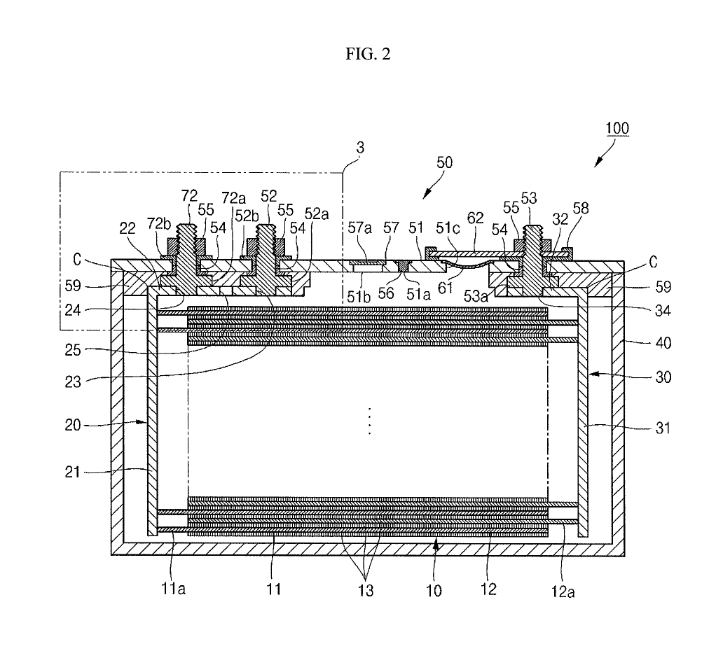

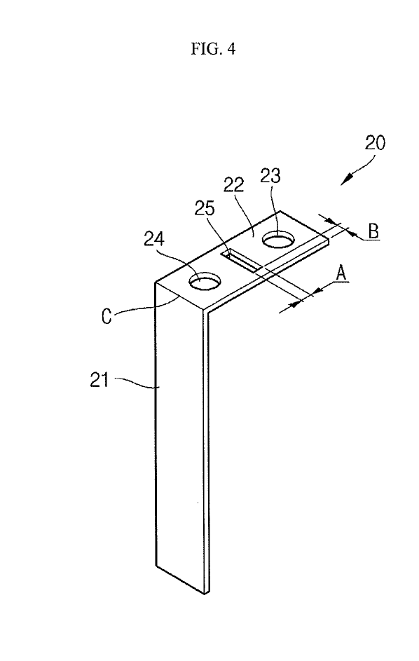

Referring to FIG. 4, the first collector plate 20 may be made of a conductive material such as aluminum or an aluminum alloy. The first collector plate 20 may come into contact with the first electrode non-coated portion 11a protruding from one end of the electrode assembly 10 to be electrically connected to the first electrode plate 11 (see FIG. 2). The first collector plate 20 may include a first connection part 21, a first extension part 22, a first electrode terminal hole 23, a sub terminal hole 24 and a fuse part 25.

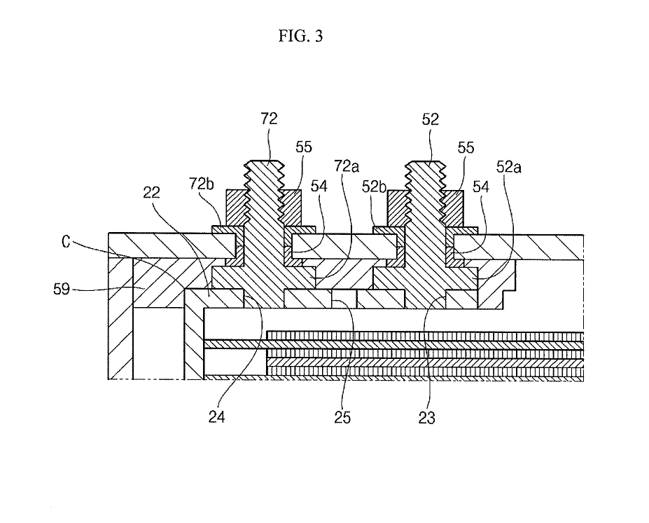

The first connection part 21 and the first extension part 22 may bend from each other. The first connection part 21 may have a plate shape and may substantially contact the first electrode non-coated portion 11a. A bent portion where the first extension part 22 and the first connection part 21 bend from each other is denoted in FIGS. 3-6 by the reference character ‘C.’ The first extension part 22 and the first connection part 21 may be perpendicular to each other at the bent portion C.

The first electrode terminal hole 23 may be located in the first extension part 22 between the fuse part 25 and an end of the first extension part 22. The first electrode terminal hole 23 may provide a space into which the first electrode terminal 52 of the cap assembly 50 is inserted and coupled.

The sub terminal hole 24 may be located in the first extension part 22 between the fuse part 25 and the bent portion C where the first connection part 21 and the first extension part 22 meet. The sub terminal hole 24 may provide a space into which the sub terminal 72 (to be described below) is inserted and coupled.

The fuse part 25 may be positioned between the first electrode terminal hole 23 and the sub terminal hole 24. The fuse part 25 may be formed at a fuse area of the first extension part 22 denoted in FIG. 4 by the reference character ‘A’. The fuse part 25 may be created by forming the fuse area A of the first collector plate 20 to have a sectional area smaller than remaining regions of the first collector plate 20, excluding the regions where the first electrode terminal hole 23 and the sub terminal hole 24 are formed. The fuse part 25 may be in the form of a gap having a rectangle shape elongated in a widthwise direction of the first extension part 22, but in other implementations, other shapes and configurations of the fuse part 25 may be used. In FIG. 4, a distance between an end of the gap forming the fuse part 25 and an edge of the first extension part 22 is denoted by the reference character ‘B.’ When a large amount of current flows through the first collector plate 20, the fuse area A may be melted by heat generated by the current, so that the fuse part 25 may function as a fuse preventing the flow of current between the electrode assembly 10 and the first electrode terminal 52, case 40 and cap plate 51.

When the fuse area A is melted, the fuse part 25 interrupts the current flow between the first electrode terminal 52 and the first electrode plate 11. In the present embodiment, the sub terminal 72 coupled to the sub terminal hole 24 is electrically connected to the first electrode plate 11. Accordingly, the first collector plate 20 may be able to forcibly discharge the current remaining in the secondary battery 100 after the secondary battery 100 is short-circuited due to an over-charge. As described above, the remaining current may be eliminated by a forced discharge, thereby improving the stability of the short-circuited secondary battery 100.

The second collector plate 30 may be made of a conductive material such as copper, a copper alloy, nickel or a nickel alloy. The second collector plate 30 may come into contact with the second electrode non-coated portion 12a protruding from the other end of the electrode assembly 10 to be electrically connected to the second electrode plate 12. The second collector plate 30 may include a second connection part 31, a second extension part 32 and a second electrode terminal hole 34.

The second connection part 31 and the second extension part 32 may be bent from each other. The second connection part 31 may have the shape of a plate and may substantially contact the second electrode non-coated portion 12a. A bent portion where the second extension part 32 and the second connection part 31 meet is denoted by the reference character ‘C’ in FIG. 2 The second extension part 32 and the second connection part 31 may be perpendicular to each other at the bent portion C. The second electrode terminal hole 34 may provide a space in the second extension part 32 into which the second electrode terminal 53 is inserted and coupled.

The case 40 may be made of a conductive material such as aluminum, an aluminum alloy or nickel plated steel. The case 40 may be shaped approximately in the form of a hexahedron having an opening in which the electrode assembly 10, the first collector plate 20 and the second collector plate 30 are inserted and placed. FIG. 2 shows a state in which the case 40 and the cap assembly 50 are assembled with each other. Accordingly, an opening is not illustrated in FIG. 2. It is to be understood that the opening is a substantially opened portion that is sealed by the cap assembly 50. The inner surface of the case 40 may be insulated. Accordingly, the case 40 may be electrically insulated from the electrode assembly 10, the first collector plate 20 and the second collector plate 30.

The cap assembly 50 may be coupled to the case 40. In detail, the cap assembly 50 may include a cap plate 51, the first electrode terminal 52, the sub terminal 72, the second electrode terminal 53, gaskets 54 and nuts 55. In addition, the cap assembly 50 may include a plug 56, a vent plate 57, an upper insulating member 58 and a lower insulating member 59.

The cap plate 51 may seal the opening of the case 40 and may be formed of the same material as the case 40. The cap plate 51 may have an electrolyte injection hole 51a, a vent hole 51b and a short-circuit hole 51c.

The first electrode terminal 52 penetrates one side of the cap plate 51 and is electrically connected to the first collector plate 20. The first electrode terminal 52 may have a pillar shape. A screw thread may be formed on an outer peripheral edge of an upper pillar exposed to an upper portion of the cap plate 51. A flange 52a may be formed in a lower pillar positioned below the cap plate 51 to prevent the first electrode terminal 52 from being dislodged from the cap plate 51. Part of the lower pillar positioned below the flange 52a of the first electrode terminal 52 may be fitted into the first electrode terminal hole 23 of the first collector plate 20. The first electrode terminal 52 may be electrically connected to the cap plate 51 through a connection plate 52b. The connection plate 52b may be disposed between the first electrode terminal 52 and the cap plate 51, and the first electrode terminal 52 may be fitted into the connection plate 52b. The connection plate 52b may be brought into close contact with the cap plate 51 and one of the gaskets 54 through the tightening of one of the nuts 55.

The second electrode terminal 53 penetrates the other side of the cap plate 51 and is electrically connected to the second collector plate 30. The second electrode terminal 53 may have the same shape as the first electrode terminal 52. Accordingly, a description thereof will not be repeated. However, the second electrode terminal 53 is insulated from the cap plate 51 instead of being electrically connected to the cap plate 51, as is the first electrode terminal 52.

The gaskets 54 may be made of an insulating material and may be positioned between each of the first electrode terminal 52 and the second electrode terminal 53 and the cap plate 51 to seal gaps between each of the first electrode terminal 52 and the second electrode terminal 53 and the cap plate 51. The gaskets 54 may prevent external moisture from infiltrating into the secondary battery 100 or may prevent an electrolyte contained within the secondary battery 100 from flowing to the outside of the secondary battery 100.

The nuts 55 may be engaged with each of the first electrode terminal 52 and the second electrode terminal 53 along screw threads formed on the first electrode terminal 52 and the second electrode terminal 53, thereby fixing the first electrode terminal 52 and the second electrode terminal 53 to the cap plate 51.

In other implementations, the first electrode terminal 52, the sub terminal 72 and the second electrode terminal may penetrate a side of the case 40 instead of penetrating the cap plate 51.

The plug 56 may seal the electrolyte injection hole 51a of the cap plate 51. The vent plate 57 may be installed in the vent hole 51b of the cap plate 51 and may include a notch 57a configured to be opened at a preset pressure.

The upper insulating member 58 may be formed between the second electrode terminal 53 and the cap plate 51 so that the second electrode terminal 53 is fitted into the upper insulating member 58. In addition, the upper insulating member 58 may come into close contact with the cap plate 51 and the gasket 54. The upper insulating member 58 may insulate the second electrode terminal 53 from the cap plate 51. In addition, the upper insulating member 58 may also insulate the short-circuit plate 62 (to be described below) and the cap plate 51.

The short-circuit member 60 may include an inverting plate 61 and a short-circuit plate 62. The short-circuit member 60 may induce a short circuit when the internal pressure of the secondary battery 100 exceeds a preset pressure, so that the fuse area A of the fuse part 25 is melted, thereby interrupting the current flow.

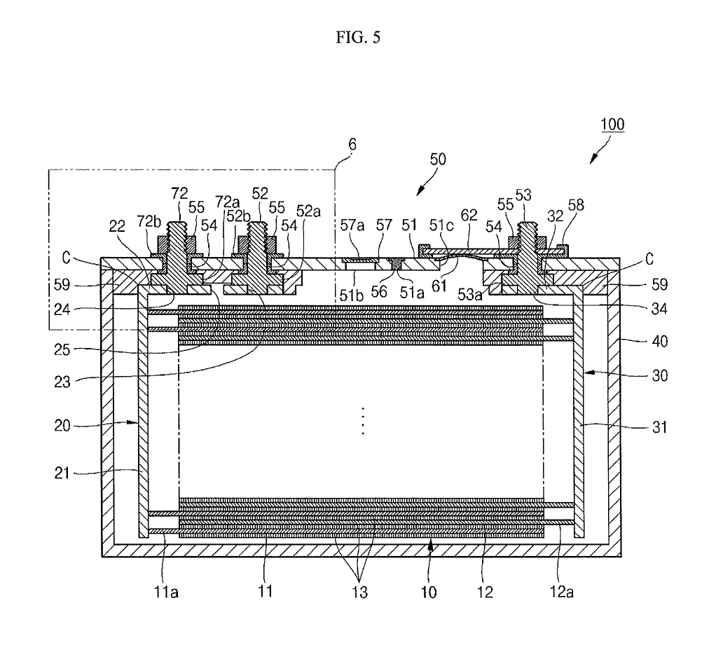

Referring to FIG. 5, the inverting plate 61 may be installed in the short-circuit hole 51c of the cap plate 51. The inverting plate 61 may have a round part (not shown) that is convexly disposed toward the electrode assembly 10 and an edge part (not shown) that is fixed to a stepped surface (not shown) formed on an inner surface of the short-circuit hole 51c. If the internal pressure of the secondary battery 100 exceeds a preset pressure, the inverting plate 61 is inverted to be convexly bent away from the electrode assembly 10. The inverting plate 61 may be made of aluminum. In other implementations, other materials may be used for the inverting plate 61.

The short-circuit plate 62 may be formed such that the second electrode terminal 53 is fitted thereto from the outside and such that the short-circuit plate 62 is spaced apart from the cap plate 51. The short-circuit plate 62 may extend across at least a portion of the short-circuit hole 51c such that the short-circuit plate 62 may be contacted when the inverting plate 61 is inverted due to an internal pressure of the secondary battery 100 in excess of a preset pressure. The short-circuit plate 62 may be electrically connected to the second electrode terminal 53. The short-circuit plate 62 may be formed as a flat plate using a copper material. In other implementations, other configurations may be provided and other materials may be used.

When the internal pressure of the secondary battery 100 rises to be higher than the preset pressure due to an over-charge, etc., the short-circuit member 60 may operate, so that the first electrode terminal 52 and the second electrode terminal 53 may be electrically connected to the cap plate 51, thereby allowing the fuse part 25 to operate and ultimately ensuring the stability of the secondary battery 100 in use. The secondary battery 100 includes a sub terminal 72 to enable self discharge after the fuse part 25 operates.

The sub terminal 72 may have the same or similar shape as the first electrode terminal 52 or the second electrode terminal 53. Accordingly, a description of similar features will not be repeated. An insulating member 72b may be formed to be inserted between the sub terminal 72 and the cap plate 51. As a result, the sub terminal 72 may be electrically insulated from the cap plate 51. After the secondary battery 100 is short-circuited, the case 40 and the cap plate 51 may be maintained at an electrically neutral state, thereby achieving stability of the secondary battery 100 in use.

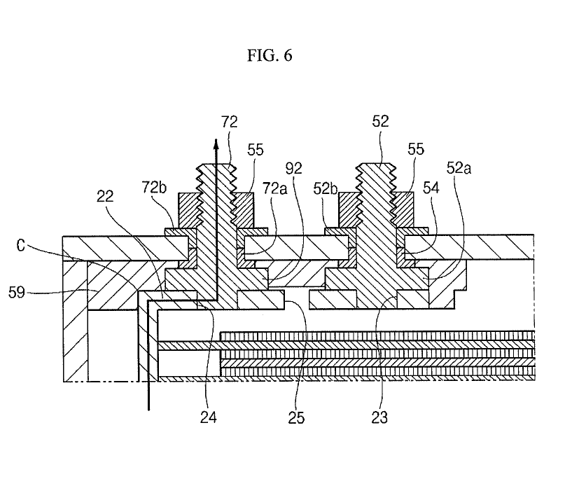

Referring to FIG. 6, even if the fuse area A of the fuse part 25 is melted, the sub terminal 72 may remain electrically connected to the first collector plate 20. The current remaining in the secondary battery 100 can be completely discharged by a forced discharge using the sub terminal 72 and the second electrode terminal 53. As a result, after the secondary battery 100 is short-circuited, the case 40 and the cap plate 51 may be maintained in an electrically neutral state. The internal current of the secondary battery 100 may be completely discharged, thereby improving the stability of the secondary battery 100 in removal or storage of the secondary battery 100.

Hereinafter, a secondary battery according to another embodiment will be described.

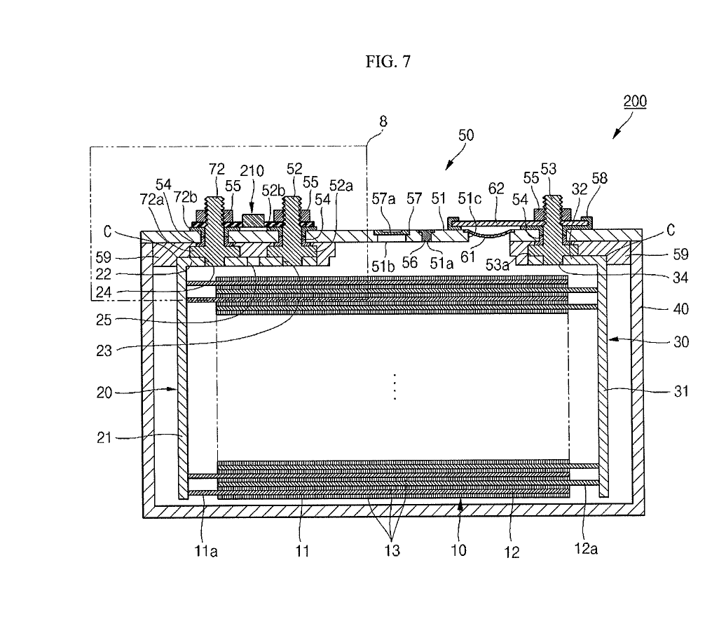

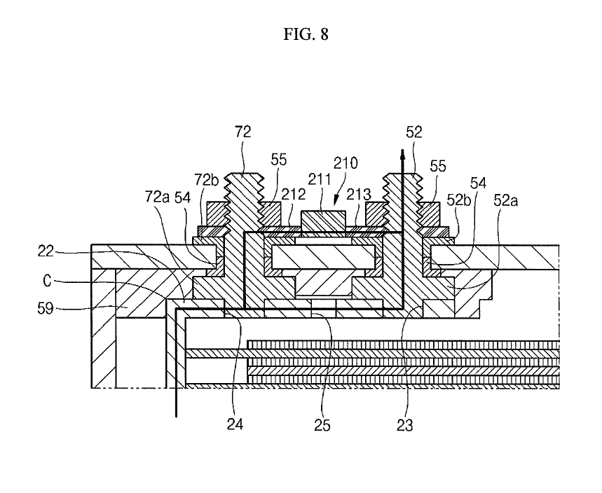

FIG. 7 illustrates a cross-sectional view corresponding to FIG. 2, illustrating a secondary battery according to another embodiment, and FIG. 8 illustrates an enlarged cross-sectional view of a region 8 shown in FIG. 7.

The secondary battery 200 according to the embodiment illustrated in FIGS. 7 and 8 differs from the secondary battery 100 illustrated in FIGS. 1 to 4, in that a resistor 210 is formed between the first electrode terminal 52 and the sub terminal 72. A description of aspects of the secondary battery 200 that are the same as those of the secondary battery 100 according to the previous embodiment will not be repeated.

The resistor 210 may include a main body 211, a first lead 212 and a second lead 213. The resistor 210 may electrically connect the first electrode terminal 52 and the sub terminal 72 on the cap plate 51. The resistor 210 and the fuse part 25 of the first collector plate 20 may be electrically connected to each other in parallel. The main body 211 may have a resistance value of 100 mΩ or greater.

When the internal pressure of the secondary battery 200 increases to the preset pressure due to an over-charge, the short-circuit member 60 may operate to allow the first electrode terminal 52 and the second electrode terminal 53 to be electrically connected to the cap plate 51, thereby allowing the fuse part 25 to operate. As shown in FIG. 8, the fuse part 25 and the resistor 210 may be connected to each other in parallel. Accordingly, it may be possible to prevent an arc from being created in the fuse part 25 by the current flowing from the first collector plate 20 to the first electrode terminal 52. In addition, the resistor 210 may be positioned outside of the secondary battery 200. Accordingly, the electrolyte and the electrode assembly 10 may not be damaged even if the resistor 210 is broken or excessive heat is generated in the secondary battery 200 due to a large amount of current flowing in the resistor 210.

In addition, when the secondary battery 200 is short-circuited, the fuse area A of the fuse part 25 may be melted to disconnect the first electrode terminal from the first electrode plate. To prevent an arc from being created, such an arc preventing the first electrode terminal 52 from being disconnected from the first electrode plate 11, the current remaining in the secondary battery 200 may be forcibly discharged using the sub terminal 72. In this case, since a current flow path during a forced discharge may be the same as that shown in FIG. 6, a detailed description thereof will not be repeated.

Therefore, when the secondary battery 200 includes the resistor 210, it may be possible to prevent a fire from occurring in the secondary battery 200 without causing damage to the electrolyte and the electrode assembly 10 when the fuse area A of the fuse part 25 is melted. In addition, after the secondary battery 200 is short-circuited, the internal current of the secondary battery 200 may be completely discharged while maintaining the case 40 and the cap plate 51 in an electrically neutral state, thereby achieving stability of the secondary battery 100 in removal or storage of the secondary battery 200.

By way of summation and review, when the internal pressure of a typical secondary battery rises and excessive heat is generated due to an over-charge or decomposition of an electrolyte, an explosion and fire may result. In a typical secondary battery, when a current interrupting function is actuated due to an over-charge, an arc may be created in the battery. The arc, combined with heat generated from the battery, may result in the ignition of an electrolyte contained in the case.

Embodiments disclosed therein may advance the art by providing a secondary battery that can be forcibly discharged when a current interrupting function is actuated under a condition of a high voltage and a high current flow. The secondary battery may include a sub terminal that forcibly discharges a current remaining in the battery when a current interrupting function is actuated, thereby improving the stability of the battery.

Embodiments may also provide a secondary battery that has a resistor configured to prevent an arc from being created in the battery when the current interrupting function is actuated. The resistor may be provided between an electrode terminal and a sub terminal. In particular, even if an arc is created or the resistor is broken, the resistor, which is positioned outside the secondary battery, may prevent an electrolyte and an electrode assembly from being damaged, thereby improving the stability of the battery.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope as set forth in the following claims.

What is claimed is:

1. A secondary battery, comprising:
an electrode assembly including a first electrode, a second electrode and a separator between the first electrode and the second electrode;
a first collector plate including a first connection part connected to the first electrode and a first extension part extending from the first connection part, the first extension part including a fuse part located therein;
a case accommodating the electrode assembly;
a first electrode terminal penetrating the case and connected to the first extension part; and
a sub terminal penetrating the case and electrically connected to the first extension part,
wherein the sub terminal is connected to the first extension part between the first connection part and the fuse part, and the first electrode terminal is connected to the first extension part between the fuse part and an end of the first extension part.

2. The secondary battery as claimed in claim 1, wherein the first electrode terminal and the sub terminal are disposed such that when the fuse part is melted, the first electrode is electrically connected only to the sub terminal.

3. The secondary battery as claimed in claim 1, wherein the first extension part includes a first electrode terminal hole through which the first extension part and the first electrode terminal are connected and a sub terminal hole through which the first extension part and the sub terminal are connected.

4. The secondary battery as claimed in claim 1, wherein the first electrode terminal is electrically connected to the case.

5. The secondary battery as claimed in claim 1, further comprising an insulating member between the sub terminal and the case.

6. The secondary battery as claimed in claim 1, further comprising a second electrode terminal that penetrates the case, the second electrode terminal being connected to the second electrode.

7. The secondary battery as claimed in claim 6, wherein:
the second electrode terminal is connected to the second electrode through a second collector plate, and
the second collector plate includes a second connection part connected to the second electrode and a second extension part extending from the second connection part and having a terminal hole through which the second electrode terminal is coupled to the second extension part.

8. The secondary battery as claimed in claim 6, further including a short circuit member that induces a short circuit between the second electrode terminal and the case when an internal pressure of the secondary battery exceeds a preset pressure.

9. The secondary battery as claimed in claim 6, further including an insulating member between the second electrode terminal and the case.

10. The secondary battery as claimed in claim 1, further comprising a resistor that electrically connects the first electrode terminal and the sub terminal.

11. The secondary battery as claimed in claim 10, wherein the resistor is on an outer portion of the case.

12. The secondary battery as claimed in claim 11, wherein the resistor and the fuse part are electrically connected to each other in parallel.

13. The secondary battery as claimed in claim 10, wherein the resistor has a resistance value of 100 mΩ or higher.

14. The secondary battery as claimed in claim 6, wherein:
the case includes a cap assembly including a cap plate coupled to the case, and
the first electrode terminal, the second electrode terminal and the sub terminal penetrate the cap plate.

15. The secondary battery as claimed in claim 14, wherein the first electrode terminal is electrically connected to the cap plate

16. The secondary battery as claimed in claim 14, further including a first insulating member between the sub terminal and the cap plate and a second insulating member between the second electrode terminal and the cap plate.

17. The secondary battery as claimed in claim 14, further comprising a resistor that electrically connects the first electrode terminal and the sub terminal, the resistor being on an outer portion of the cap plate.
